(19) United States
(12) Patent Application Publication
(10) Pub. No.: US 2026/0341609 A1
(43) Pub. Date: Oct. 29, 2026

(54) MODULAR BUTTON ASSEMBLY FOR CONTROLLER

(71) Applicant: Hit Box, L.L.C., Las Vegas, NV (US)

(72) Inventors: Shawn Huffer, Henderson, NV (US); Dustin Huffer, Henderson, NV (US)

(21) Appl. No.: 19/191,418

(22) Filed: Apr. 28, 2025

(51) Int. Cl. H01H 13/14; H01H 9/22; H01H 13/04

(52) U.S. Cl. CPC H01H 13/14; H01H 9/22; H01H 13/04

(57) ABSTRACT

A button assembly for a controller includes a housing defining a cavity, a plurality of ribs extending within the cavity, a plurality of slots formed in the housing and including a locking recess and a lip extending about a perimeter of the housing. A plunger is disposed within the cavity of the housing and translates between an unengaged position and an engaged position in which the plunger triggers an action associated with the button assembly. A cap is coupled to the plunger, such that depression of the cap translates the plunger between the unengaged position and the engaged position, and a rim is coupled to the housing and rotatable between a locked position and an unlocked position, with the rim including a plurality of locking tabs that engage the locking recess of each of the plurality of slots in the locked position.

### FIELD OF THE INVENTION

The embodiments described herein relate to input devices for electronic gaming systems and, more particularly, to modular button assemblies compatible with arcade-style controllers.

### BACKGROUND

Arcade-style video game controllers are a staple in both casual and competitive gaming environments, offering a tactile and responsive interface for a variety of games. Traditional arcade-style controllers typically offer buttons for movement and other in-game actions, such as jumping, dashing, kicking, punching, and other similar actions. However, many conventional arcade-style controllers include buttons which are enclosed in a housing of the controller, which requires a user to disassemble the controller housing in order to access and perform routine maintenance or other customization on the buttons. Furthermore, the buttons employed in traditional arcade-style controllers lack modularity, which minimizes the ability of a user to upgrade and/or tune the various components of the controller to the particular preferences of the user.

As a result, users of traditional arcade-style controllers often resort to modifying traditional controllers in order to accommodate user preferences. These modifications often require a user to disassemble the controller, which makes replacing and/or service the buttons a difficult and time-consuming endeavor. Accordingly, a need exists for a modular button assembly that allows a user to easily service and customize traditional controllers.

### SUMMARY OF THE DISCLOSURE

In embodiments of the present disclosure, a button assembly for a controller is disclosed. The button assembly includes a housing defining a cavity, a plurality of ribs extending within the cavity, a plurality of slots formed in the housing and including a locking recess and a lip extending about a perimeter of the housing. A plunger is disposed within the cavity of the housing and translates between an unengaged position and an engaged position in which the plunger triggers an action associated with the button assembly. A cap is coupled to the plunger, such that depression of the cap translates the plunger between the unengaged position and the engaged position, and a rim is coupled to the housing and rotatable between a locked position and an unlocked position, with the rim including a plurality of locking tabs that engage the locking recess of each of the plurality of slots in the locked position.

In another embodiment of the present disclosure a button assembly for a controller is disclosed. The button assembly includes a housing defining a cavity, a plurality of ribs extending within the cavity, a plurality of slots formed in the housing and including a locking recess, and a lip extending about a perimeter of the housing. A plunger is disposed within the cavity of the housing and is translatable between an unengaged position and an engaged position. A switch is positioned within the housing, such that the plunger engages the switch in the engaged position and the switch triggers an action associated with the button assembly. A damper insert is positioned between the switch and the plunger, and a cap is coupled to the plunger, such that depression of the cap translates the plunger between the unengaged position and the engaged position. A rim is coupled to the housing and is rotatable between a locked position and an unlocked position, the rim including a plurality of locking tabs that engage the locking recess of each of the plurality of slots in the locked position.

In yet another embodiment of the present disclosure, a button assembly for a controller is disclosed. The button assembly includes a housing defining a cavity, a plunger disposed within the cavity of the housing and being translatable between an unengaged position and an engaged position, a cap coupled to the plunger, and a rim coupled to the housing and rotatable between a locked position and an unlocked position.

These aspects and other advantages and features are apparent from the following description taken in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 is a perspective view of a modular button assembly, according to one or more embodiments shown and described herein;

FIG. 2 is a cross-sectional view of the modular button assembly of FIG. 1, according to one or more embodiments shown and described herein;

FIG. 3 is a perspective view of a housing of the modular button assembly of FIG. 1, according to one or more embodiments shown and described herein;

FIG. 4A is a top-side view of a rim of the modular button assembly of FIG. 1, according to one or more embodiments shown and described herein;

FIG. 4B is a bottom-side view of the rim of FIG. 4A, according to one or more embodiments shown and described herein;

FIG. 5 is a partially-exploded view of an interface between the rim and the housing of the modular button assembly of FIG. 1, according to one or more embodiments shown and described herein;

FIG. 6 is a partial perspective view of a cap and a plunger of the modular button assembly of FIG. 1, according to one or more embodiments shown and described herein;

FIG. 7 is a front-side view of the cap and the plunger of FIG. 6, according to one or more embodiments shown and described herein;

FIG. 8A is a perspective view of the plunger of FIGS. 6 and 7, according to one or more embodiments shown and described herein;

FIG. 8B is a perspective view of the cap of FIGS. 6 and 7, according to one or more embodiments shown and described herein; and

FIG. 9A is a top-side view of a damper insert of the modular button assembly of FIG. 1, according to one or more embodiments shown and described herein;

FIG. 9B is a top-side view of the damper insert of FIG. 9A installed within the housing of the modular button assembly of FIG. 1, according to one or more embodiments shown and described herein;

FIG. 10A is a top-side view of the damper insert of FIGS. 9A and 9B including a travel limit indicator, according to one or more embodiments shown and described herein;

FIG. 10B is a top-side view of the travel limit indicator of FIG. 10A; and

FIG. 11 is an illustrative flow diagram of a method of modifying the modular button assembly of FIG. 1, according to one or more embodiments shown and described herein.

### DETAILED DESCRIPTION

Embodiments disclosed herein relate to a modular button assembly for a controller. The modular button assembly may include a housing having a cavity, a plurality of ribs extending within the cavity, a plurality of slots formed in the housing, each of the plurality of slots including a locking recess and a lip extending about a perimeter of the housing. The modular button assembly may further include a plunger disposed within the cavity of the housing and being translatable between an unengaged position and an engaged position in which the plunger triggers an action associated with the button assembly, a cap coupled to the plunger, such that depression of the cap translates the plunger between the unengaged position and the engaged position, and a rim coupled to the housing and rotatable between a locked position and an unlocked position, the rim including a plurality of locking tabs that engage the locking recess of each of the plurality of slots in the locked position. The various components of the modular button assembly may be removed from the housing of the button assembly and replaced with other similar components offering varying performance, tactile impressions, and visual appearances without removing the housing of the button assembly from a buttonhole of a controller, thereby allowing a user to quickly and easily customize the controller.

As should be appreciated, arcade-style video game controllers are commonly used in both casual and competitive gaming environments, offering a tactile and responsive interface for a variety of games. Traditional arcade-style controllers typically offer a plurality of buttons for in-game actions, such as jumping, dashing, kicking, punching, and other similar actions. However, standard arcade-style controllers present limitations when users wish to customize and/or replace traditional buttons utilized in standard controllers. For example, button assemblies that are available for traditional controllers provide limited functionality and feel for users, which minimizes the ability of the user to customize the controller. Furthermore, modifying traditional controllers with currently available buttons may interfere with the ergonomic design of the controller, which may negatively affect the gameplay experience of the user.

The disclosed modular button assembly aims to resolve these issues by providing a top-accessible modular assembly that allows a user to replace and/or modify buttons within a controller without disassembling or otherwise modifying the physical structure of the controller. In particular, the modular button assembly may include a rotatable locking rim that engages a surface of the controller housing and may be removed to allow a user to access internal components of the modular button assembly.

Once the rim is removed from the modular button assembly, a user may modify the internal components of the button in order to customize button performance. For example, in some embodiments, a user may insert and/or remove a damper insert within the modular button assembly in order to alter a tactile response of the button and/or dampen an acoustic output of the button, as will be described in additional detail herein.

Moreover, the modular button assembly may include a removable and/or interchangeable cap that acts as the input mechanism for the modular button assembly. The cap may be removed and/or swapped to adjust a height, surface curvature, texture, material, or visual appearance of the modular button assembly without impacting any of the underlying components of the modular button assembly situated within the housing of the controller.

Accordingly, by utilizing the modular button assembly described herein, users may be able to customize buttons provided on traditional arcade-style controllers, providing for enhanced controller functionality while preserving the original design and ergonomics of the controller.

Embodiments of modular button assemblies, controllers, and methods for modifying modular button assemblies will now be described in additional detail herein. The following will now describe these multi-input adaptors, controllers, and methods in more detail with reference to the drawings and where like numbers refer to like structures.

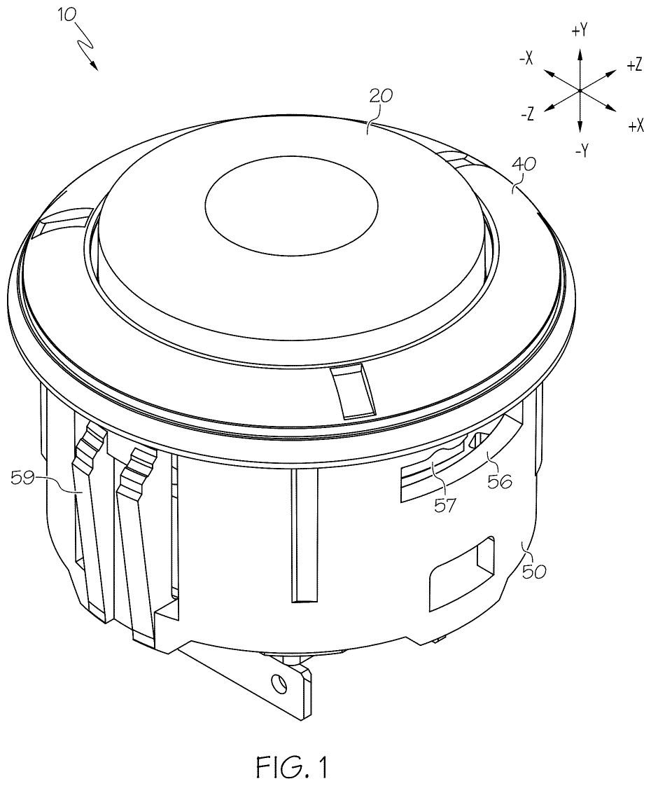

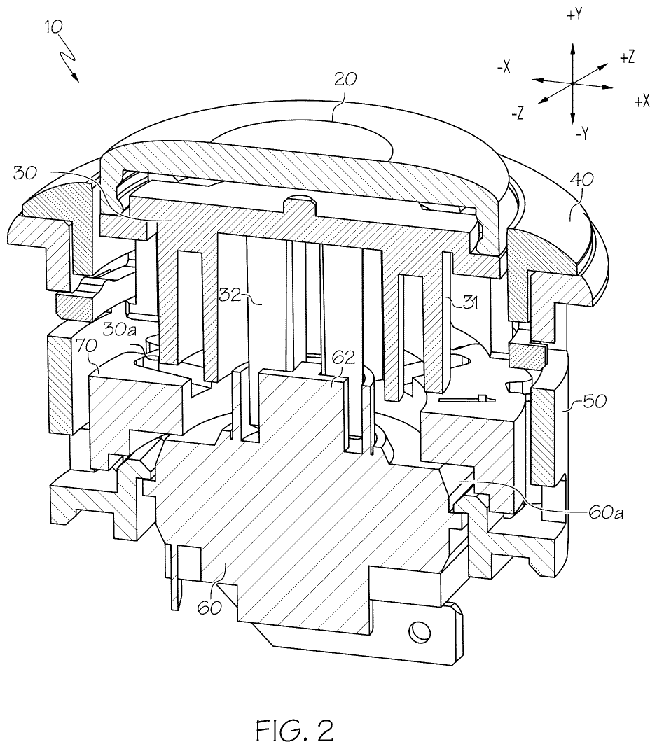

Referring now to FIGS. 1 and 2, a modular button assembly 10 is depicted. In these embodiments, the modular button assembly 10 may include a cap 20, a plunger 30, a rim 40, a housing 50, a switch 60, and a damper insert 70. It should be appreciated that the various components of the modular button assembly 10 may be assembled and/or disassembled without removing the housing 50 from a controller housing of a controller (not depicted) in which the modular button assembly 10 is positioned. Furthermore, the various components of the modular button assembly 10 may be interchangeable with other similar components offering unique performance and/or efficiency, as will be described in additional detail herein.

Referring still to FIGS. 1 and 2, the housing 50 of the modular button assembly may be sized and/or shaped such that the housing 50 may be insertable into a standard buttonhole formed on a traditional arcade-style controller, or any other similar controller. The housing 50 may further define a cavity 52, in which the plunger 30 and the switch 60 may be positioned. In these embodiments, the plunger 30 may include a plurality of legs 31 extending about a perimeter of the plunger 30 and a plurality of feet 32 positioned concentrically within the plunger 30 that interface with and electrically couple the plunger 30 to the switch 60. Accordingly, actuation of the plunger 30 may trigger the switch 60 to initiate an action (e.g., movement, jump, dash, kick, punch, etc.) associated with the modular button assembly 10, as will be described in additional detail herein. Furthermore, in the embodiments described herein, the plurality of legs 31 of the plunger 30 may aid in positioning the plunger 30 within the cavity 52 of the housing 50, such that the plurality of feet 32 of the plunger align with and engage the switch 60, as has been described hereinabove.

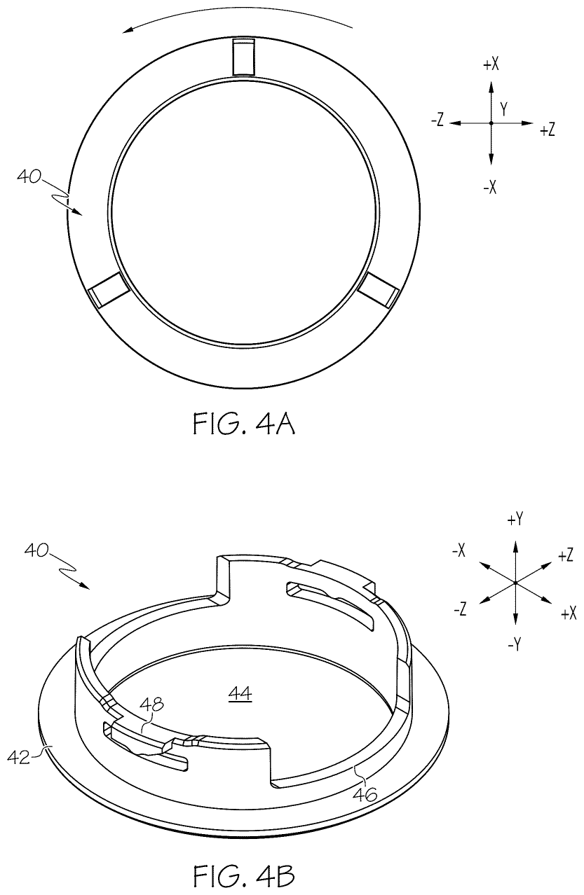

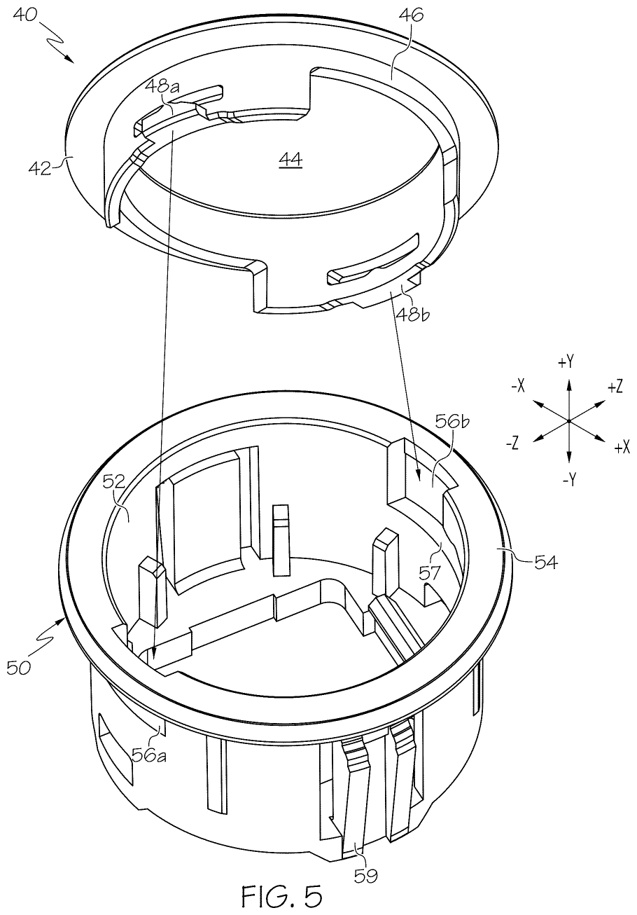

As further depicted in FIGS. 1 and 2, the housing 50 may further include a lip 54, which may protrude from and/or extend about a perimeter of the housing 50. In these embodiments, the rim 40 may be secured within the housing 50 such that a collar 42 of the rim 40 engages the lip 54 of the housing when the rim 40 is coupled to the housing 50, as will be described in additional detail herein with reference to FIGS. 4A-5.

In the embodiments described herein, the rim 40 may further define an opening 44 in which the cap 20 is positioned. As depicted most clearly in FIG. 2, the plunger 30 may be positioned concentrically with the opening 44 of the rim 40, such that the cap 20 may be secured to the plunger 30 when the cap 20 is positioned within the opening 44 formed in the rim 40. In these embodiments, the cap 20 may act as a user interface for the modular button assembly 10, such that depression of the cap 20 by a user actuates the plunger 30 and triggers the action associated with the modular button assembly 10, as will be described in additional detail herein.

As further depicted in FIG. 2, in some embodiments, the modular button assembly 10 may further include a damper insert 70 disposed within the cavity 52 of the housing 50. In these embodiments, the damper insert 70 may be positioned between a bottom surface 30a of the plunger and a top surface 60a of the switch 60, with the damper insert 70 being configured to limit actuation (e.g., travel) of the plunger 30 in a vertical direction (e.g., in the −y-direction as depicted in the coordinate axes of FIGS. 1 and 2). Accordingly, it should be appreciated that the damper insert 70 may modify the haptic response, the acoustic response, and the performance of the modular button assembly 10, as will be described in additional detail herein.

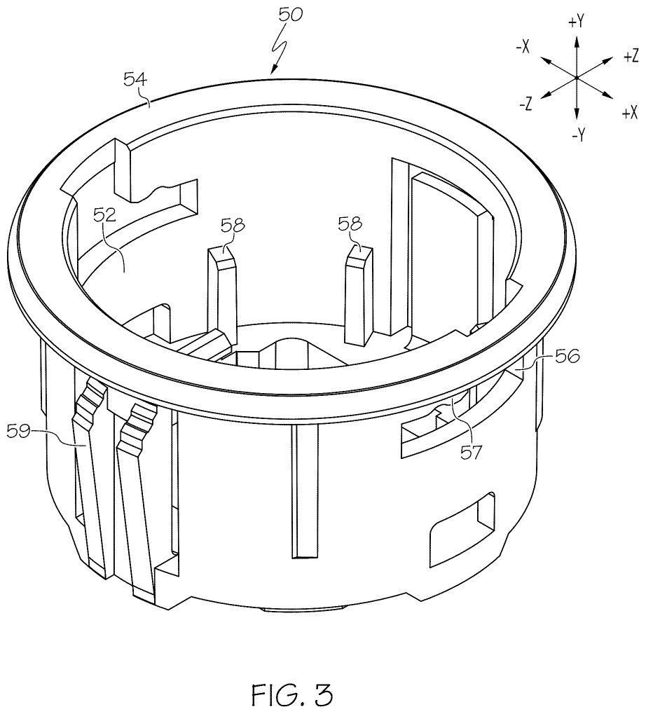

Referring now to FIGS. 1-3, the housing 50 of the modular button assembly 10 is described in additional detail. As illustrated most clearly in FIG. 3, the housing 50 may further include a plurality of slots 56, with each of the plurality of slots 56 defining a locking recess 57. In these embodiments, the plurality of slots 56 may be configured to receive at least a portion of the rim 40, and secure the rim 40 within the locking recess 57 of each of the plurality of slots 56. Interfacing of the rim 40 and the housing 50 will be described in additional detail herein with reference to FIG. 5.

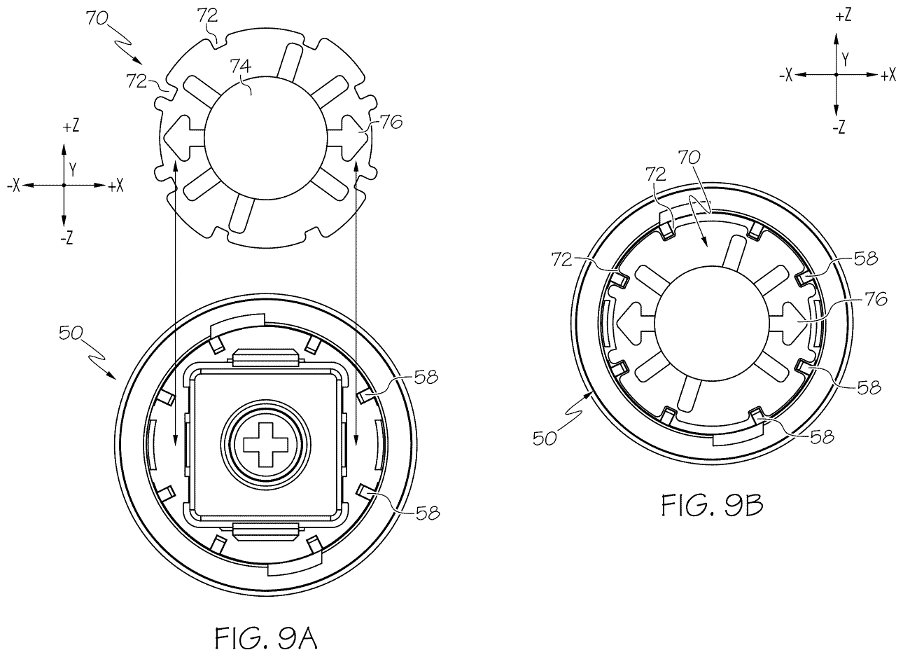

Referring still to FIGS. 1-3, the housing 50 may further include a plurality of ribs 58 which extend about the cavity 52 defined within the housing 50. In these embodiments, the plurality of ribs 58 may protrude from an interior surface of the housing 50 into the cavity 52, and may extend from a bottom surface of the housing 50 towards the lip 54 of the housing (e.g., in the +y-direction as depicted in the coordinate axis of FIG. 3) such that the plurality of ribs 58 extend at least partially through the cavity 52 of the housing 50. In embodiments in which the damper insert 70 is implemented in the modular button assembly 10, the plurality of ribs 58 may be used to position the damper insert 70 within the cavity 52 of the housing 50, as will be described in additional detail herein with reference to FIGS. 9A and 9B.

Furthermore, in embodiments in which the damper insert 70 is not inserted within the cavity 52 defined by the housing 50, the plurality of legs 31 extending about the perimeter of the plunger 30 may engage with an upper surface of each of the plurality of ribs 58 to limit translation of the plunger 30 in a downward direction (e.g., in the-y-direction as depicted in the coordinate axes of FIGS. 1-3). Translation of the plunger 30 between an engaged and an unengaged position will be described in additional detail herein.

As depicted most clearly in FIG. 3, the housing 50 may also include a plurality of clips 59 that extend outwardly from an outer surface of the housing 50 and are configured to secure the housing 50 within a controller. For example, in these embodiments, the plurality of clips 59 may be biased in a radially outward direction relative the housing 50 in an uncompressed position, but may be pressed inwardly to a compressed position to allow the housing 50 to be situated within a buttonhole of the controller (not depicted). In these embodiments, a user may provide a manual force (e.g., squeeze, etc.) each of the plurality of clips 59 simultaneously, such that the housing 50 may be positioned within a buttonhole of a controller. Once the housing 50 clears the buttonhole, a user may release the plurality of clips 59, which may cause the plurality of clips 59 to return to the uncompressed position in which the plurality of clips 59 are biased outwardly from the housing 50. In these embodiments, the outward bias of the plurality of clips 59 may act to secure the housing 50 within the buttonhole of the controller.

Referring now to FIGS. 4A and 4B, the rim 40 of the modular button assembly 10 is depicted in additional detail. For example, in these embodiments, the rim 40 may be an annularly shaped rim, with the opening 44 defined concentrically within the rim 40. As depicted most clearly in FIG. 4B, a flange 46 may extend from a bottom surface of the rim 40 (e.g., in the +y-direction as depicted in the coordinate axis of FIG. 4B) and a plurality of locking tabs 48 may extend outwardly from the flange 46. In these embodiments, the plurality of locking tabs 48 may be used to secure the rim 40 to the housing 50 of the modular button assembly 10, as will be described in additional detail with reference to FIG. 5.

Although the rim 40 depicted in FIGS. 4A and 4B is depicted as being an annularly shaped rim, it should be appreciated that the rim 40 may take any shape without departing from the scope of the present disclosure. For example, the rim 40 may include a square, rectangular, elliptical, or any other similar shape that includes a concentrically defined opening. Furthermore, it should be appreciated that the shape of the rim 40 may correspond to a shape of the cap 20, such that the cap 20 and the rim 40 include the same shape, as will be described in additional detail herein.

Turning now to FIG. 5, an interface of the rim 40 and the housing 50 will be described in additional detail. For example, in these embodiments, the rim 40 may be inserted into the housing 50, such that the flange 46 of the rim 40 extends at least partially into the cavity 52 defined by the cavity 52. As the flange 46 of the rim 40 is positioned within the cavity 52 of the housing 50, the plurality of locking tabs 48 may engage the plurality of slots 56 formed in the housing 50. For example, in the embodiment depicted in FIG. 5, the flange 46 may include a first locking tab 48a insertable within a first slot 56a formed in the housing 50, and a second locking tab 48b insertable within a second slot 56b formed in the housing 50. Furthermore, the collar 42 of the rim 40 may engage the lip 54 of the housing 50 as the plurality of locking tabs 48 are inserted within the plurality of slots 56 formed within the housing 50.

With the plurality of locking tabs 48 of the rim 40 positioned within the plurality of slots 56 of the housing 50, the rim 40 may be rotatable relative the housing 50 between a locked position, in which the rim 40 is secured to the housing 50, and an unlocked position, in which the rim 40 may be removed from the housing 50. For example, the rim 40 may be rotated in a first direction (e.g., a counter-clockwise direction) to move the rim 40 from the locked position to the unlocked position. In these embodiments, as the rim 40 is rotated in the first direction, the plurality of locking tabs 48 may traverse the plurality of slots 56 until the plurality of locking tabs 48 engage the locking recess 57 formed in each of the plurality of slots 56. The plurality of locking tabs 48 may form an interference fit with the locking recess 57 of each of the plurality of slots 56 to secure the rim 40 within the housing 50 in the locked position.

In contrast, the rim 40 may be moved from the locked position to the unlocked position by rotating the rim 40 in a second direction (e.g., a clockwise direction) opposite the first direction. In these embodiments a user may apply a manual rotational force to the rim 40 that is sufficient to overcome the interference fit formed between the plurality of locking tabs 48 and the locking recess 57 of each of the plurality of slots 56. With the plurality of locking tabs 48 disengaged from the locking recess 57 of each of the plurality of slots 56, rotation of the rim 40 in the second direction may continue until the rim 40 may be removed from the housing 50. In the embodiments described herein, it should be appreciated that removal of the rim 40 from the housing 50 may allow a user to access various components of the modular button assembly 10 situated within the cavity 52 of the housing 50, as will be described in additional detail herein.

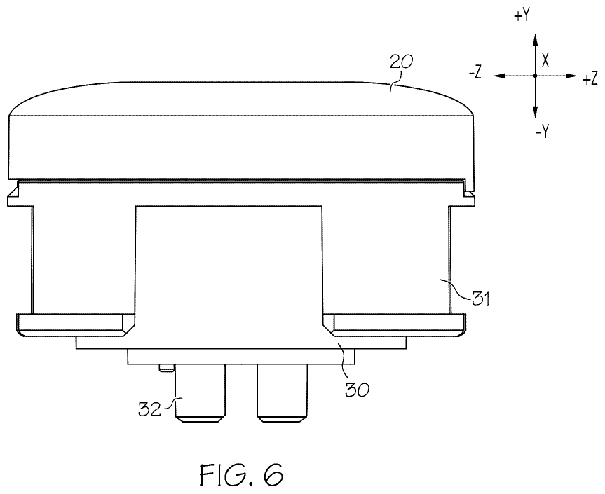

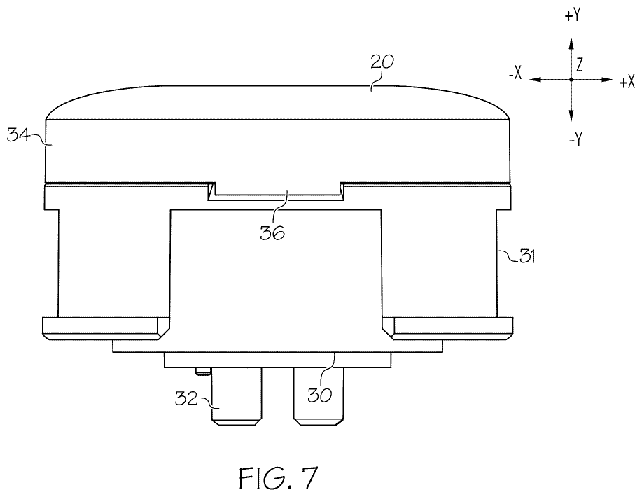

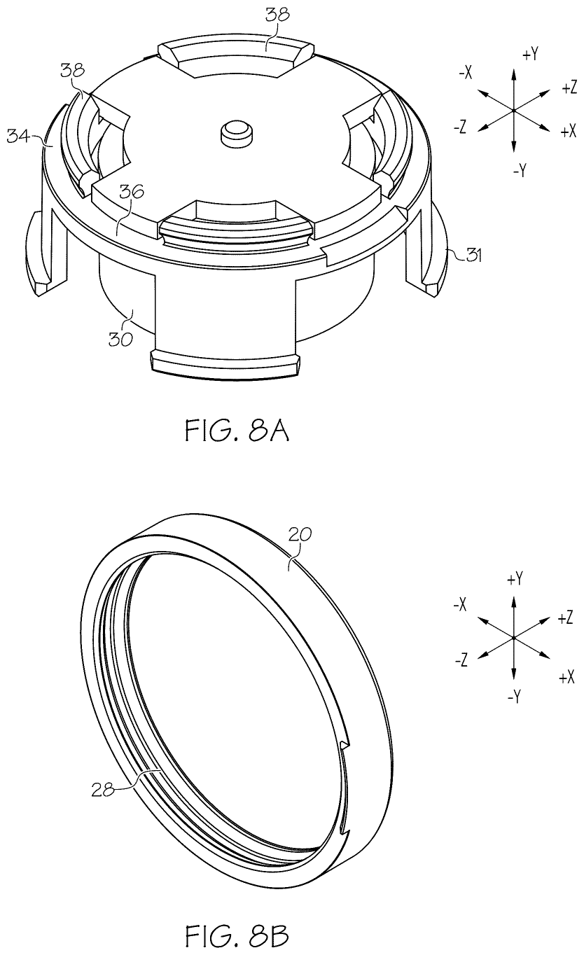

Turning now to FIGS. 6-8B, the cap 20 and the plunger 30 of the modular button assembly 10 are depicted in additional detail. In these embodiments, the cap 20 may be coupled to the plunger 30 via a snap-fit, or any other similar type of coupling, such that the cap 20 may be removable from the plunger 30. For example, as depicted most clearly in FIGS. 7 and 8A, the plunger 30 may define a shoulder 34 which engages the cap 20, and a notch 36 may be formed in the shoulder 34. In these embodiments, the notch 36 may be formed in a portion of the shoulder 34 that contacts the cap 20, such that a user may engage the notch 36 to separate (e.g., manually or via a tool) the cap 20 from the plunger 30.

In these embodiments, the plunger 30 may further include a plurality of projections 38 that extend upwardly (e.g., in the +y-direction as depicted in the coordinate axis of FIG. 8A) from the shoulder 34. The plurality of projections 38 may be configured to engage a plurality of grooves 28 formed within an interior surface of the cap 20, such that, when the cap 20 is secured to the plunger 30, the plurality of grooves 28 of the cap 20 form a snap-fit (or other similar interference fit) with the plurality of projections 38 of the plunger 30 to couple the cap 20 to the plunger 30.

Although the cap 20 is described and depicted herein as forming a snap-fit with the plunger 30, it should be appreciated that the cap 20 and plunger 30 may be connected via any releasable coupling without departing from the scope of the present disclosure. For example, in some embodiments, the cap 20 may include a threaded coupling, or any other similar coupling, without departing from the scope of the present disclosure.

In the embodiments described herein, it should be further appreciated that a user may remove the cap 20 and replace the cap with a different cap component that offers distinct features to modify either the performance, feel, or visual appearance of the modular button assembly. For example, the cap 20 may be removed from the plunger 30 and replaced with a separate cap having a different color, texture, material, height (e.g., relative the rim 40 and/or a surface of the controller), or profile in order to customize gameplay without needing to disassemble the controller in which the modular button assembly is positioned. During replacement of the cap 20, the plunger 30 may remain secured within the housing 50, thereby maintaining electrical continuity and switch alignment of the modular button assembly.

Referring now to FIGS. 9A and 9B, the damper insert 70 is depicted inserted within the housing 50 of the modular button assembly 10. In these embodiments, the damper insert 70 may include a plurality of channels 72 formed about a perimeter of the damper insert 70, with the plurality of channels 72 being configured to engage the plurality of ribs 58 formed in the cavity 52 of the housing 50 to position and secure the damper insert 70 within the housing 50.

In these embodiments, the damper insert 70 may further define a hole 74 positioned concentrically within the damper insert 70. As depicted in FIGS. 9A and 9B, at least a portion of the switch 60 may extend through the hole 74 of the damper insert 70, such that the damper insert 70 may be positioned at least partially between the plunger 30 and the switch 60 when the modular button assembly 10 is assembled.

As further depicted in FIGS. 9A and 9B, the damper insert 70 may further include an alignment indicator 76 disposed on at least one surface of the damper insert 70. In these embodiments, the alignment indicator 76 may indicate to directional orientation of the damper insert 70 to the user, such that a user may easily dispose the damper insert 70 within the housing.

In the embodiments described herein, the damper insert 70 may limit actuation (e.g., travel) of the plunger 30 based on a thickness of the damper insert 70. For example, installation of the damper insert 70 may reduce a travel distance of the plunger 30 that is required for the plunger 30 to engage the switch 60 and initiate an action associated with the modular button assembly 10. That is, increasing the thickness of the damper insert 70 may reduce the travel distance of the plunger 30, thereby altering the tactile response of the modular button assembly.

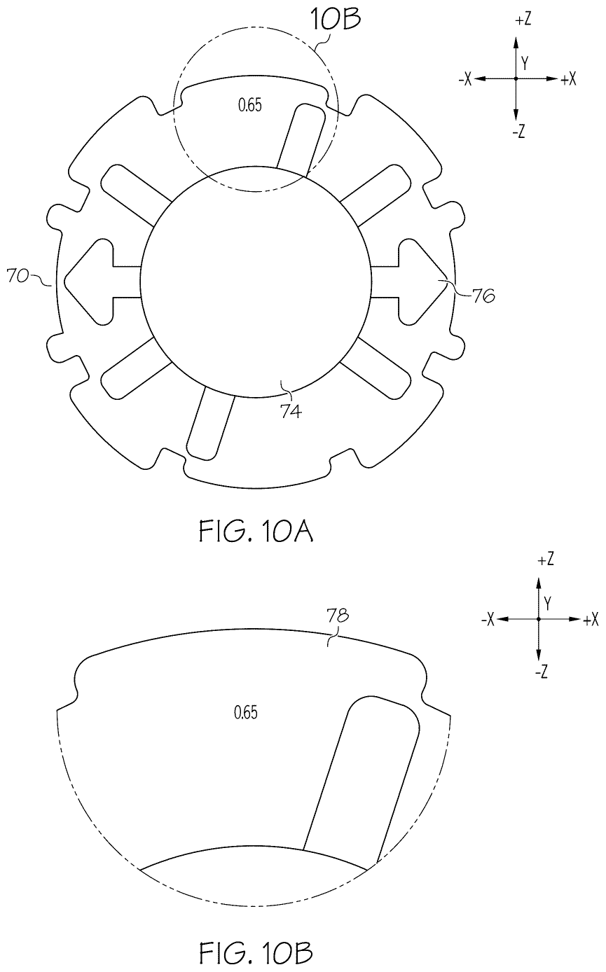

For example, FIGS. 10A and 10B depict damper insert 70 as further including a travel limit indicator 78. In these embodiments, the travel limit indicator 78 indicates to a distance the plunger 30 may travel to trigger the switch 60 once the damper insert 70 is positioned within the housing 50. For example, inserting the damper insert 70 depicted in FIGS. 10A and 10B into the modular button assembly 10 described herein may reduce the travel distance of the plunger 30 from a standard distance (e.g., approximately 2 mm) to a reduced distance of 0.65 mm. Operation of the damper insert 70 and plunger 30 will be described in additional detail herein.

Referring now to FIGS. 1-10B collectively, assembly and operation of the modular button assembly will now be described in detail. Initially, as described hereinabove, the plurality of clips 59 of the housing 50 may be depressed (e.g. manually or otherwise) by a user, such that the housing 50 may be disposed within a buttonhole of a controller (not depicted). As the housing 50 is inserted in the buttonhole, a user may release the plurality of clips 59, such that the plurality of clips 59 are biased radially outward from the housing 50 and secure the housing 50 within the buttonhole of the controller.

With the housing 50 secured within the buttonhole, the switch 60 may be installed within the housing 50, such that the switch 60 is electrically coupled to the controller and positioned within the cavity 52 of the housing 50. In the embodiments described herein, it should be appreciated that the switch 60 may be a micro-switch, such as a low-profile micro-switch, or any other similar microcontroller configured for use in a traditional arcade-style controller environment. Activation of the switch 60 may initiate an action associated with the modular button assembly 10, as will be described in additional detail herein.

Once the switch 60 is wired and secured within the cavity 52 of the housing 50, a user may insert the damper insert 70 into the housing 50 such that the plurality of channels 72 formed in the damper insert 70 engage the plurality of ribs 58 extending into the cavity 52 of the housing 50. In these embodiments, the damper insert 70 may be positioned within the housing 50 such that a stem 62 of the switch 60 extends through the hole 74 formed in the damper insert 70, thereby allowing the switch 60 to be coupled to the plunger 30, as will be described in additional detail herein.

Although the assembly of the modular button assembly 10 described herein includes insertion of the damper insert 70, it should be appreciated that, in some embodiments, the modular button assembly 10 may be assembled without inserting the damper insert 70 into the housing 50. Furthermore, in embodiments, the damper insert 70 may be replaced by damper inserts having various types, as will be described in additional details herein.

After the damper insert 70 is positioned in the housing 50, the plunger 30 may be inserted within the cavity 52 of the housing 50 such that the plurality of feet 32 of the plunger 30 extend into and contact the stem 62 of the switch 60 (e.g., as depicted most clearly in FIG. 2). In these embodiments, with the plurality of feet 32 connected to the stem 62 of the switch 60, the bottom surface 30a of the plunger 30 may be positioned adjacent the damper insert 70, such that actuation of the plunger 30 forces the bottom surface 30a into contact with the damper insert 70, as will be described in additional detail herein.

Referring still to FIGS. 1-10 collectively, once installed, the shoulder 34 and the plurality of projections 38 of the plunger 30 may extend at least partially above the lip 54 of the housing 50, such that the cap 20 may be secured to the plunger 30. For example, and as described hereinabove, the cap 20 may be press-fit onto the plunger 30, such that the plurality of grooves 28 formed within an interior surface of the cap 20 engage the plurality of projections 38 extending from the shoulder 34 of the plunger 30.

In these embodiments, the plunger 30 and the cap 20 may be positioned concentrically within the housing 50, such that a gap exists between the housing 50 and an outer perimeter of both the plunger 30 and the cap 20 when the plunger 30 and cap 20 are secured within the housing 50. As described hereinabove, the rim 40 may be further secured within the housing 50, such that the flange 46 of the rim 40 extends into the gap formed between the housing 50 and the plunger 30 and cap 20 and the plurality of locking tabs 48 formed on the flange 46 of the rim 40 engage the plurality of slots 56 formed in the housing 50.

Referring still to FIGS. 1-10 collectively, the rim 40 may be positioned within the housing 50 such that the collar 42 of the rim 40 abuts the lip 54 of the housing 50 and the plurality of locking tabs 48 engage the plurality of slots 56. With the rim 40 positioned, the rim 40 may be rotated from the unlocked position to the locked position, such that the plurality of locking tabs 48 engage the locking recess 57 formed in each of the plurality of slots 56.

Once the rim 40 is positioned within the housing 50, the modular button assembly 10 may be considered fully assembled and prepared for engagement by a user. In operation, a user may operate the modular button assembly 10 by depressing the cap 20, which may in turn cause the plunger 30 to translate from an unengaged position to an engaged position.

In these embodiments, in the unengaged position, the plurality of feet 32 of the plunger 30 may not activate the switch 60 of the modular button assembly 10, such that the plunger 30 does not trigger an action associated with the modular button assembly 10. In contrast, in the engaged position, the plurality of feet 32 of the plunger 30 may trigger the switch to perform the action associated with the modular button assembly 10. Accordingly, in the embodiments described herein, a user may trigger an action associated with the modular button assembly by depressing the cap 20, which is turn translates the plunger 30 between the engaged position and the unengaged position.

Referring still to FIGS. 1-10 collectively, a travel distance of the plunger 30 may be defined as a vertical distance that the plunger 30 travels between the engaged position and the unengaged position. Furthermore, as described hereinabove, the insertion of the damper insert 70 may alter the travel distance of the plunger 30.

For example, in embodiments in which the damper insert 70 is installed within the housing 50 of the modular button assembly 10, depression of the cap 20 may cause the plunger 30 to translate such that the bottom surface 30a of the plunger 30 contacts the damper insert 70. In these embodiments, contact between the plunger 30 and the damper insert 70 may trigger the switch at a reduced travel distance (e.g. as compared to embodiments in which no damper insert 70 is utilized), such that the action associated with the modular button assembly 10 is performed at smaller travel distance. For example, in embodiments in which the damper insert 70 is not used, the plunger 30 may travel a travel distance of 2 mm between the unengaged position and the engaged position (e.g., in which the action associated with the modular button assembly is triggered). In contrast, insertion of the damper insert 70 may reduce the travel distance of the plunger 30 to a desired travel distance based on the thickness of the damper insert 70. For example, inserting a damper insert 70 having a thickness of 1.35 mm may reduce the travel distance of the plunger 30 to 0.65 mm, such that the plunger 30 may travel a distance of 0.65 mm between the unengaged position and the engaged position.

It should be appreciated that reducing the travel distance of the plunger 30 (e.g., the distance traveled to engage the switch 60) may similarly reduce a return distance of the plunger 30 (e.g., the distance the plunger 30 travels from the engaged position to the unengaged position). Accordingly, reducing the travel distance of the plunger 30 may allow the plunger 30, and in turn, the cap 20, to return to the unengaged position more quickly, which may allow a user to trigger the action associated with modular button assembly 10 more rapidly and/or more repeatedly. Furthermore, minimizing the travel distance that a user must depress the cap 20, and in turn, the plunger 30, to trigger the action associated with the modular button assembly 10 may also aid in alleviating user fatigue, particularly during gameplay sessions involving games which utilize hundreds of actions.

Furthermore, it should be appreciated that the damper insert 70 described herein may be made of a material that is capable of suppressing mechanical noise associated with operation of the modular button assembly 10 and/or altering the tactile response of the cap 20 and/or plunger 30 of the modular button assembly 10. For example, the damper insert 70 described herein may be formed of silicone rubber, thermoplastic elastomer, polyurethane, foamed polymers, rubber-metal composites, silicone, or any other similar material without departing from the scope of the present disclosure.

It should be further understood that, in these embodiments, the damper insert 70 may also be configured to impact tactile characteristics of the modular button assembly 10, as the insertion of the damper insert 70 between the plunger 30 and the switch 60 may modify the mechanical response of the modular button assembly 10 and the sensory feedback that a user experiences when depressing the cap 20, as has been described in detail herein. For example, in some embodiments, the damper insert 70 may be formed of a material that absorbs a portion of the energy generated when the plunger 30 translates, when may result in a softer button feel for the user. In these embodiments, the cushioning provided by the damper insert 70 may reduce finger fatigue of a user, particularly during long and/or repetitive gameplay sessions.

Moreover, the material of the damper insert 70 may impact the rebound of the plunger 30, and in turn, the travel distance the plunger 30 moves between the engaged and the unengaged position. For example, utilizing a damper insert 70 may cause the plunger 30 to compress more deeply into the damper insert 70 and recover more slowly. In contrast, a damper insert 70 formed of a relatively more firm material may compress minimally and rebound more quickly, providing a quicker and/or snappier button feel to the user.

Furthermore, the material used to form the damper insert 70 may impact the tactile feedback and resistance of the plunger 30 of the modular button assembly 10, as the damper insert 70 may cause the user to feel progressive resistance as opposed to a hard mechanical stop. In embodiments in which a stiff material is utilized to form the damper insert 70, the user may experience a crisper and/or firm rebound, while a damper insert 70 formed of a relatively softer material may provide a smoother and/or dampened release.

Referring again to FIGS. 1-10 collectively, and as described in detail herein, the various components of the modular button assembly 10 may be modular in nature, such that the various components may be replaced with components offering different tactile, performance, or visual experiences for a user without departing from the scope of the present disclosure.

For example, and as described hereinabove, a user may remove the rim 40 from the modular button assembly 10 by rotating the rim 40 from the locked position to the unlocked position. With the rim 40 removed from the modular button assembly 10, the user may replace any of the components stored within the housing 50 (e.g., the cap 20, the plunger 30, and/or the damper insert 70) to adjust operation of the modular button assembly 10.

Referring still to FIGS. 1-10, and as described hereinabove, a user may engage the notch 36 formed on the shoulder 34 of the plunger 30 to separate the cap 20 from the plunger 30. For example, the user may remove a first cap having a first type (e.g., having a first shape, material, profile, texture, visual appearance, etc.) and replace the first cap with a second cap having a second type (e.g., a second shape, material, profile, texture, visual appearance, etc.) that is different from the first type.

Similarly, once the cap 20 is removed from the plunger 30, the user may, in some embodiments, replace a first plunger having a first type with a second plunger having a second type. For example, the first plunger may include a first plurality of feet having a first length, with the first length of the first plurality of feet impacting the travel distance of the first plunger (e.g., between the unengaged position and the engaged position). In these embodiments, rather than adjusting the travel distance via the damper insert, a user may replace the first plunger with a second plunger having a second type, in which the second plunger includes a second plurality of feet having a second length that is different from the first length of the first plurality of feet. It should be appreciated that adjusting a length of the plurality of feet 32 may similarly adjust the travel distance of the plunger 30, as has been described in detail herein.

In embodiments in which the plunger 30 is replaced with a plunger having a different type (e.g., the first type, second type, or another similar type, as has been described in detail hereinabove), it should be further appreciated that the rim 40 may further act to limit translation of the plunger 30 in a direction towards the unengaged position (e.g., in the +y-direction as depicted in the coordinate axes of FIGS. 1-10B). Accordingly, adjusting the type of the plunger 30 (e.g., adjusting the length of the plurality of feet 32 of the plunger 30) may cause the rim 40 to hold the plunger 30 in a partially depressed position even when the plunger 30 is translated to the unengaged position. Because the plunger 30 is maintained in a partially depressed position by the rim 40, the travel distance of the plunger 30 may be adjusted as described hereinabove, which may further impact the sensitivity of the module button assembly. Furthermore, by utilizing the rim 40 to retain the plunger 30, it may be possible for a user to implement a variety of plungers 30 in the module button assembly 10 without altering a height of the cap 20 of the module button assembly 10 relative the rim 40 and/or a surface of the controller.

Furthermore, in some embodiments, the user may remove the plunger 30 from the housing 50 and either remove or replace the damper insert 70. For example, a user may remove a first damper insert having a first type (e.g., material, thickness, etc.) and replace the first damper insert with a second damper having a second type different from the first type. Additionally, the user may simply remove the first damper insert from the housing 50, which may similarly adjust the travel distance of the plunger 30, as has been described in detail herein.

Moreover, in some embodiments, a user may remove the damper insert 70 from the module button assembly 10 and continue to use the module button assembly 10 without the damper insert 70. In these embodiments, when the plunger 30 is translated to the engaged position, the plurality of legs 31 extending about the perimeter of the plunger 30 may contact the upper surface of each of the plurality of ribs 58 to limit the travel distance of the plunger 30. For example, contact between the plurality of legs 31 of the plunger 30 and the upper surfaces of the plurality of ribs 58 of the housing may act as a hard stop on translation of the plunger 30 from the unengaged position to the engaged position, thereby ensuring that the plunger 30 does not translate a travel distance beyond the travel distance required to engage the switch 60 and trigger the action associated with the module button assembly 10.

Accordingly, it should be appreciated that the modular button assembly 10 described herein may be used in connection with any number of caps 20, plungers 30, and/or damper inserts 70 without departing from the scope of the present disclosure.

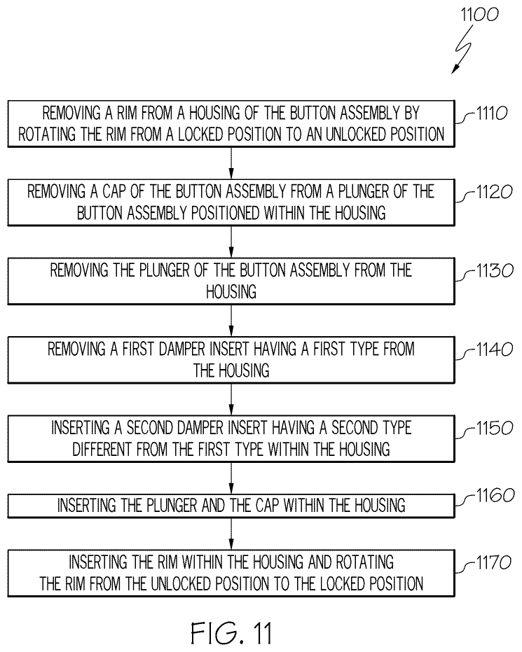

Turning now to FIG. 11, an illustrative flow diagram of a method 1100 of modifying a modular button assembly is disclosed. In these embodiments, the method may being at block 1110, which may involve removing a rim from a housing of the button assembly by rotating the rim from a locked position to an unlocked position. In these embodiments, rotating the rim from the locked position to the unlocked position may further involve rotating the rim such that a plurality of locking tabs formed on the rim disengage a locking recess formed in each of a plurality of slots formed in the housing.

Referring still to FIG. 11, in these embodiments, the method may further involve removing a cap of the button assembly from a plunger of the button assembly positioned within the housing and removing the plunger of the button assembly from the housing, as illustrated at block 1120 and 1130, respectively. With the plunger and cap removed, the method may advance to block 1140, which may involve removing a first damper insert having a first type from the housing.

In the embodiments described herein, the “type” of the first damper may refer to a material composition, a thickness, or any other similar physical and/or dimensional quality of the first damper. For example, as described herein, the first damper may include a first thickness, or may be formed of a first material.

As further illustrated in FIG. 11, the method may further involve inserting a second damper insert having a second type different from the first type within the housing, as shown at block 1150. For example, in these embodiments, the second damper may have a second thickness that is different from the first thickness of the first damper insert, or be formed of a second material that is different from the first material of the first damper insert.

With the second damper insert positioned within the housing, the method may further involve inserting the plunger and the cap within the housing and inserting the rim within the housing and rotating the rim from the unlocked position to the locked position, as depicted at blocks 1160 and 1170, respectively.

In view of the foregoing, it should be appreciated that embodiments described herein relate to a modular button assembly for a controller and methods of modifying a button assembly for a controller. In the embodiments described herein, a user may replace a variety of components positioned within a housing of the button assembly without removing the housing of the button assembly from a controller, thereby allowing a user to customize and/or modify the button assembly on the controller without disassembling or otherwise modifying the controller.

The embodiments disclosed herein may be further described with reference to the following aspects:

According to one aspect of the disclosure, and potentially in combination with other disclosed aspects of the disclosure, a button assembly is disclosed. The button assembly includes a housing comprising: a cavity; a plurality of ribs extending within the cavity; a plurality of slots formed in the housing, each of the plurality of slots including a locking recess; and a lip extending about a perimeter of the housing; a plunger disposed within the cavity of the housing and being translatable between an unengaged position and an engaged position in which the plunger triggers an action associated with the button assembly; a cap coupled to the plunger, such that depression of the cap translates the plunger between the unengaged position and the engaged position; and a rim coupled to the housing and rotatable between a locked position and an unlocked position, the rim including a plurality of locking tabs that engage the locking recess of each of the plurality of slots in the locked position.

According to one aspect of the disclosure, and potentially in combination with other disclosed aspects of the disclosure, the housing further comprises a plurality of clips that are biased radially outward from the housing.

According to one aspect of the disclosure, and potentially in combination with other disclosed aspects of the disclosure, the plunger further comprises a shoulder that engages the cap.

According to one aspect of the disclosure, and potentially in combination with other disclosed aspects of the disclosure, the shoulder of the plunger further includes a plurality of projections configured to engage a plurality of grooves formed on an interior surface of the cap.

According to one aspect of the disclosure, and potentially in combination with other disclosed aspects of the disclosure, a switch is positioned within the housing, the switch being configured to trigger the action associated with the button assembly.

According to one aspect of the disclosure, and potentially in combination with other disclosed aspects of the disclosure, the plunger further includes a plurality of feet that engage the switch and triggers the action associated with the button assembly when the plunger is translated to the engaged position.

According to one aspect of the disclosure, and potentially in combination with other disclosed aspects of the disclosure, the rim further comprises a flange extending from a bottom surface of the rim, and the plurality of locking tabs are formed on the flange.

According to one aspect of the disclosure, and potentially in combination with other disclosed aspects of the disclosure, the rim further defines an opening and the cap is coupled to the plunger such that the cap extends through the opening defined by the rim.

According to one aspect of the disclosure, and potentially in combination with other disclosed aspects of the disclosure, a damper insert is positioned in the housing adjacent a bottom surface of the plunger and is configured to reduce a travel distance of the plunger between the unengaged position and the engaged position.

According to one aspect of the disclosure, and potentially in combination with other disclosed aspects of the disclosure, the damper insert further comprises a plurality of channels that engage the plurality of ribs of the housing when the damper insert is positioned in the housing.

According to one aspect of the disclosure, and potentially in combination with other disclosed aspects of the disclosure, the damper insert further comprises an alignment indicator that indicates a directional orientation of the damper insert to a user.

According to one aspect of the disclosure, and potentially in combination with other disclosed aspects of the disclosure, the damper insert further comprises a travel limit indicator that indicates the travel distance of the plunger to a user when the damper insert is positioned within the housing.

According to one aspect of the disclosure, and potentially in combination with other disclosed aspects of the disclosure, a button assembly is disclosed. The button assembly includes a housing comprising: a cavity; a plurality of ribs extending within the cavity; a plurality of slots formed in the housing, each of the plurality of slots including a locking recess; and a lip extending about a perimeter of the housing; a plunger disposed within the cavity of the housing and being translatable between an unengaged position and an engaged position; a switch positioned within the housing, such that the plunger engages the switch in the engaged position and the switch triggers an action associated with the button assembly; a damper insert positioned between the switch and the plunger; a cap coupled to the plunger, such that depression of the cap translates the plunger between the unengaged position and the engaged position; and a rim coupled to the housing and rotatable between a locked position and an unlocked position, the rim including a plurality of locking tabs that engage the locking recess of each of the plurality of slots in the locked position.

According to one aspect of the disclosure, and potentially in combination with other disclosed aspects of the disclosure, the housing further comprises a plurality of clips that are biased radially outward from the housing.

According to one aspect of the disclosure, and potentially in combination with other disclosed aspects of the disclosure, the damper insert defines a hole and a stem of the switch extends through the hole defined by the damper insert, such that the stem of the switch engages the plunger while the damper insert is positioned between the plunger and the switch.

According to one aspect of the disclosure, and potentially in combination with other disclosed aspects of the disclosure, the damper insert is configured to reduce a travel distance of the plunger between the unengaged position and the engaged position.

According to one aspect of the disclosure, and potentially in combination with other disclosed aspects of the disclosure, the damper insert further comprises a plurality of channels that engage the plurality of ribs of the housing when the damper insert is positioned in the housing.

According to one aspect of the disclosure, and potentially in combination with other disclosed aspects of the disclosure, the damper insert further comprises an alignment indicator that indicates a directional orientation of the damper insert to a user.

According to one aspect of the disclosure, and potentially in combination with other disclosed aspects of the disclosure, the damper insert further comprises a travel limit indicator that indicates a travel distance of the plunger to a user when the damper insert is positioned within the housing.

According to one aspect of the disclosure, and potentially in combination with other disclosed aspects of the disclosure, a button assembly for a controller is disclosed. The button assembly includes a housing defining a cavity; a plunger disposed within the cavity of the housing and being translatable between an unengaged position and an engaged position; a cap coupled to the plunger; and a rim coupled to the housing and rotatable between a locked position and an unlocked position.

The terminology used herein is for the purpose of describing particular aspects only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A button assembly for a controller comprising:
a housing comprising:
a cavity;
a plurality of ribs extending within the cavity;
a plurality of slots formed in the housing, each of the plurality of slots including a locking recess; and
a lip extending about a perimeter of the housing;
a plunger disposed within the cavity of the housing and being translatable between an unengaged position and an engaged position in which the plunger triggers an action associated with the button assembly;
a cap coupled to the plunger, such that depression of the cap translates the plunger between the unengaged position and the engaged position; and
a rim coupled to the housing and rotatable between a locked position and an unlocked position, the rim including a plurality of locking tabs that engage the locking recess of each of the plurality of slots in the locked position.

2. The button assembly of claim 1, wherein the housing further comprises a plurality of clips that are biased radially outward from the housing.

3. The button assembly of claim 1, wherein the plunger further comprises a shoulder that engages the cap.

4. The button assembly of claim 3, wherein the shoulder of the plunger further includes a plurality of projections configured to engage a plurality of grooves formed on an interior surface of the cap.

5. The button assembly of claim 1, further comprising a switch positioned within the housing, the switch being configured to trigger the action associated with the button assembly.

6. The button assembly of claim 5, wherein the plunger further includes a plurality of feet that engage the switch and triggers the action associated with the button assembly when the plunger is translated to the engaged position.

7. The button assembly of claim 1, wherein the rim further comprises a flange extending from a bottom surface of the rim, and the plurality of locking tabs are formed on the flange.

8. The button assembly of claim 1, wherein the rim further defines an opening and the cap is coupled to the plunger such that the cap extends through the opening defined by the rim.

9. The button assembly of claim 1, further comprising a damper insert positioned in the housing adjacent a bottom surface of the plunger and being configured to reduce a travel distance of the plunger between the unengaged position and the engaged position.

10. The button assembly of claim 9, wherein the damper insert further comprises a plurality of channels that engage the plurality of ribs of the housing when the damper insert is positioned in the housing.

11. The button assembly of claim 9, wherein the damper insert further comprises an alignment indicator that indicates a directional orientation of the damper insert to a user.

12. The button assembly of claim 9, wherein the damper insert further comprises a travel limit indicator that indicates the travel distance of the plunger to a user when the damper insert is positioned within the housing.

13. A button assembly for a controller comprising:
a housing comprising:
a cavity;
a plurality of ribs extending within the cavity;
a plurality of slots formed in the housing, each of the plurality of slots including a locking recess; and
a lip extending about a perimeter of the housing;
a plunger disposed within the cavity of the housing and being translatable between an unengaged position and an engaged position;
a switch positioned within the housing, such that the plunger engages the switch in the engaged position and the switch triggers an action associated with the button assembly;
a damper insert positioned between the switch and the plunger;
a cap coupled to the plunger, such that depression of the cap translates the plunger between the unengaged position and the engaged position; and
a rim coupled to the housing and rotatable between a locked position and an unlocked position, the rim including a plurality of locking tabs that engage the locking recess of each of the plurality of slots in the locked position.

14. The button assembly of claim 13, wherein the housing further comprises a plurality of clips that are biased radially outward from the housing.

15. The button assembly of claim 13, wherein the damper insert defines a hole and a stem of the switch extends through the hole defined by the damper insert, such that the stem of the switch engages the plunger while the damper insert is positioned between the plunger and the switch.

16. The button assembly of claim 13, wherein the damper insert is configured to reduce a travel distance of the plunger between the unengaged position and the engaged position.

17. The button assembly of claim 13, wherein the damper insert further comprises a plurality of channels that engage the plurality of ribs of the housing when the damper insert is positioned in the housing.

18. The button assembly of claim 13, wherein the damper insert further comprises an alignment indicator that indicates a directional orientation of the damper insert to a user.

19. The button assembly of claim 13, wherein the damper insert further comprises a travel limit indicator that indicates a travel distance of the plunger to a user when the damper insert is positioned within the housing.

20. A button assembly for a controller comprising:
a housing defining a cavity;
a plunger disposed within the cavity of the housing and being translatable between an unengaged position and an engaged position;
a cap coupled to the plunger; and
a rim coupled to the housing and rotatable between a locked position and an unlocked position.
